(19) United States
(12) Patent Application Publication
(10) Pub. No.: US 2002/0073209 A1
(43) Pub. Date: Jun. 13, 2002

(54) Method for redirecting a network communication

(76) Inventor: Ronald J. Nienhuis, Marietta, OH (US)

Correspondence Address: Gerald Levy, Esq., PITNEY, HARDIN, KIPP & SZUCH LLP, 711 Third Avenue, New York, NY, 10017-4059, US

(21) Appl. No.: 09/735,203

(22) Filed: Dec. 12, 2000

Related U.S. Application Data
(60) Provisional application No. 60/170,434, filed on Dec. 13, 1999.

(51) Int. Cl. G06F 15/16

(52) U.S. Cl. 709/228; 709/226

(57) ABSTRACT

A communication received from a first information-processing device directed to a second information-processing device includes a data indicative of the geographic location of the first information-processing device. The second information-processing device redirects the communication so received from the first information-processing device to a third information-processing device in accordance with the data indicative of the geographic location of the first information-processing device. The third information-processing device then services the communication so directed.

This application claims priority of U.S. provisional application Ser. No. 60/170,434 filed on Dec. 13, 1999.

### BACKGROUND OF THE INVENTION

1. Field of the Invention

The present invention relates generally to method for processing a communication transmitted from a first information-processing device to second information-processing device across a network. More particularly, the present invention relates to a method for redirecting the communication to a third information-processing device in accordance with a data received by the second information-processing device sent from the first information-processing device.

2. Description of the Prior Art

The Internet has become a standard communications channel for both commercial users as well as the general public. In particular, the World-Wide Web (“WWW”), which is but one aspect of Internet communication, has proliferated. Web sites are identified based on the publisher's domain name(s), which may be one of the generic or international top-level domains (“TLDs”), such as “.com,” “org” or “.net”, or may be one of the country-specific TLDs, such as “.us”, “.ca” or “jp.”

Confusion can arise, however, when a second-level domain is registered in more than one TLD, which may occur for several reasons. First, there is a finite number of unique second-level domain names, and a lesser finite number of meaningful second-level domain names. Accordingly, one entity may register the second-level domain name in one TD, either a generic or country-specific TLD, and another entity may register the same second-level domain name in a different TLD. Second, a multi-national corporation may register a second-level domain name in multiple TLDs, one for each of its local operations. Alternatively, a single entity may register a second-level domain name in multiple TLDs to protect its trademark rights in the second-level domain name.

Based on the foregoing, it would be beneficial to redirect a user to one of the multiple Web sites, which have a common second-level domain. Each computer connected to the Internet is identified by a unique numeric IP address. It is inefficient, however, to accomplish such redirection based on the IP address of the user's computer for several reasons. First, the task of initially developing a sortable and searchable database of existing IP addresses is monumental. Second, searching such a database would be time consuming and inconvenient to the end user. Finally, maintaining such a database would be time consuming and inconvenient to the end user. Finally, maintaining and updating the database would require significant resources. In addition, the IP address may not conclusively identify the geographic location of the user's information processing device or computer. This is possible, for example, by connecting to an Internet service provider (“ISP”) through a dial-up connection, wherein the ISP is located in a foreign country relative to the end user. In this case, the IP address of the end user would correspond to an IP address of the ISP, which, when mapped, would indicate that the end user is located in the country of the ISP, which is clearly inaccurate.

It is an object of the present invention, therefore, to provide a method of redirecting a communication received from a first information-processing device by a second information-processing device to a third information-processing device without resolving the IP address of the first information-processing device.

### SUMMARY OF THE INVENTION

The above and other beneficial objects of the invention are most effectively attained by including with a communication, such as a Web page request, transmitted from a first information-processing device to a second information-processing device a data indicative of the geographic location of the first information-processing device. The second information-processing device redirects the communication to a third information-processing device in accordance with and based on the data. The third information-processing device then services and responds to the communication transmitted by the first information-processing device.

### BRIEF DESCRIPTION OF THE DRAWINGS

Further objects and advantages of the invention will become apparent from the following description and claims, and from the accompanying drawing, wherein:

FIG. 1 is a schematic of the present invention.

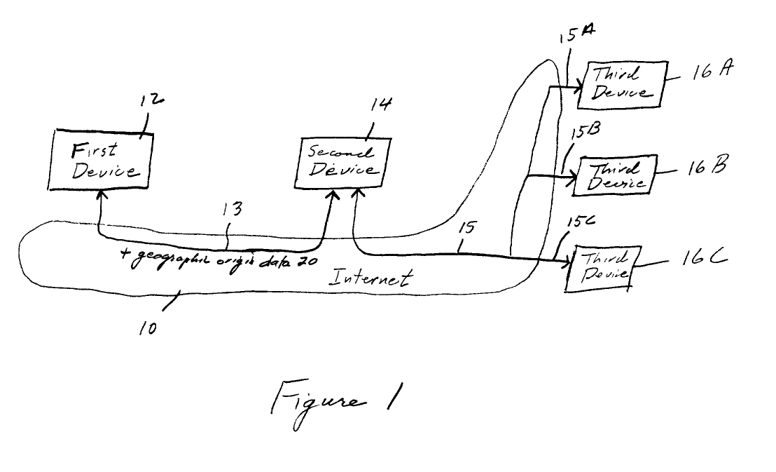

### DETAILED DESCRIPTION OF THE PREFERRED EMBODIMENTS

Referring now to the drawing in detail, one sees that the Internet 10 is a network of individual information-processing devices and sub-networks of information-processing devices. Each device connected to the Internet communicates via the TCP/IP communication protocols. To access a Web page, for example, a first information-processing device 12 sends a request 13 to a second information-processing device 14 via browser software being executed on the first information-processing device 12. The request 13 is directed to the second information-processing device based on the domain name of the second information-processing device 14 through a DNS lookup process, which resolves the domain name or Web page address to an IP address. The first information-processing device 12, as well as every other information-processing device, is uniquely identified by a corresponding IP address. The request 13 sent to the second information-processing device contains the IP address of the first information-processing device 12 so that the second information-processing device 14 can properly address its response to the request to the first information-processing device 12. According to the present invention, the request 13 sent by the first information-processing device 12 further contains a data 20, which conclusively indicates the country or other geographic location of the first information-processing device 12. Presently, there are approximately 250 countries, each of which having standardized identifying codes according to, for example, ISO 3166. It should be appreciated that the present invention, of course, is not limited to such standardized coding schemes. Accordingly, the data 20 identifying the country of origin of the first information-processing device 12 would add approximately one byte to the request. Of course, a data size of less than or more than one byte could be used.

In response to the request 13, the second information-processing device 14 will, if necessary, redirect the request to a third information-processing device 16A, 16B or 16C, etc. in accordance with the data 20, via route 15 and one of respective routes 15A, 15B or 15C, etc. The third information-processing device 16A, 16B or 16C, in turn, will service the communication and respond to the first information-processing device 12. To accomplish this redirection, the second information-processing device 14 may include a database that relates the data to a corresponding third information-processing devices 16A, 16B, 16C by, for example, IP address, domain name or Web page address.

As an example of the present invention, it is assumed that two competing companies have trademark rights in separate countries to the mark DOMAIN and each would desire the second-level domain name “domain.com.” If one of these companies registers “domain.com,” the other is precluded from registering the same. If the other of the companies then registers the second-level domain name “domain” in another TLD or some variation of “domain” in the “.com” TLD, confusion may arise. Additionally, if the two companies have rights to the mark DOMAIN in their respective countries, use of “domain.com” could be the subject of protracted litigation, during which neither company will have the opportunity to use “domain.com.” According to the present invention, each of the two companies could register an appropriate second-level domain name. For example, a company with U.S. rights to DOMAIN could register “domain-us.com” and a company with Canadian rights to DOMAIN could register “domain.ca.” A respective third information-processing device would be associated with each of “domain-us.com” and “domain.ca.” The two companies would jointly manage the second-level domain “domain.com” so that a user in the United States would be redirected by the second information-processing device 14 to the third information-processing device, such as 16A, corresponding to “domain-us.com,” whereas a user in Canada would be redirected by the second information-processing device 14 to the third information-processing device, such as 16B, corresponding to “domain.ca.” This redirection would be performed without user intervention, except for initially inputting the data 20 representing the geographic location of the first information-processing device 12, and in accordance with the data.

While the redirection is described with reference to one example, it should be appreciated that redirection in accordance with the present invention would be useful and beneficial in a myriad of circumstances, including, but in no way limited to, multinational concerns and business entities, for sales and marketing purposes, for service and warranty purposes and for language solutions. It should also be appreciated that while redirection of the present invention has been described with respect to the data representing a country or other geographic location, the present invention is in no way limited thereby. That is, the present invention encompasses redirecting a communication received from a first information-processing device by a second information-processing device to a third information-processing device in accordance with a data contained in the communication.

Thus the several aforementioned objects and advantages are most effectively attained. Although a single preferred embodiment of the invention has been disclosed and described in detail herein, it should be understood that this invention is in no sense limited thereby and its scope is to be determined by that of the appended claims.

What is claimed is:

1. In a data communication system of the type wherein a first information-processing device communicates with a second information-processing device, the improvement comprising including additional data in a request from said first information-processing device to said second information-processing device wherein, in accordance with said additional data, said second information-processing device effects communication between said first information-processing device and one of a plurality of third information-processing devices.

2. The improvement of claim 1 wherein said additional data indicates a geographic location of said first information-processing device.

3. The improvement of claim 2 wherein said additional data does not exceed one byte in length.

4. The improvement of claim 3 wherein communication between said first information-processing device, said second information-processing device, and said plurality of third information-processing devices is performed over the internet.

5. The improvement of claim 4 wherein communication between said first information-processing device, said second information-processing device, and said plurality of third information-processing devices is performed using TCP/IP format.

6. The improvement of claim 5 wherein said second information-processing device includes a database which includes addresses of each of said plurality of third information-processing devices corresponding to said additional data.
